(19) United States
(12) Patent Application Publication
(10) Pub. No.: US 2012/0139173 A1
(43) Pub. Date: Jun. 7, 2012

(54) HYDRAULIC BUSHING

(75) Inventor: Joongwook LEE, Hwaseong-si (KR)

(73) Assignee: HYUNDAI MOTOR COMPANY, Seoul (KR)

(21) Appl. No.: 13/192,319

(22) Filed: Jul. 27, 2011

(30) Foreign Application Priority Data
Dec. 3, 2010 (KR) 10-2010-0122765

(51) Int. Cl. F16F 13/14

(52) U.S. Cl. 267/140.11

(57) ABSTRACT

Provided is a hydraulic bushing which is mounted to be inserted onto an outer periphery of a propeller shaft, and effectively absorbs and reduces radial vibration and axial vibration in vertical and horizontal directions of the propeller shaft, thereby improving the vehicle steering stability and the comfortable ride. The hydraulic bushing includes a bushing body in which a plurality of pairs of upper fluid chambers and lower fluid chambers are formed in a circumferential direction, the upper fluid chamber and the lower fluid chamber of each pair being discriminated vertically in an axial direction, and an orifice including a vertical orifice passage communicating the upper fluid chambers with the lower fluid chamber, an upper orifice passage communicating the adjacent upper fluid chambers with each other, and a lower orifice passage communicating the adjacent lower fluid chambers with each other.

### CROSS-REFERENCE TO RELATED APPLICATIONS

The present application claims priority to Korean Patent Application Number 10-2010-0122765 filed Dec. 3, 2010, the entire contents of which application is incorporated herein for all purposes by this reference.

### BACKGROUND OF INVENTION

1. Field of Invention

The present invention relates to a hydraulic bushing, and more particularly, to a hydraulic bushing which includes a plurality of fluid chambers partitioned in a circumferential direction and an axial direction, and effectively absorbs and reduces axial or radial vibration or impact.

2. Description of Related Art

A propeller shaft of a conventional vehicle is installed in such a manner that it is elongated along a longitudinal direction of a vehicle so that it is supplied with engine power from a transmission and transfers the supplied engine power to rear wheels.

The propeller shaft moves up and down, left and right, and back and forth, depending on the movement of a rear suspension, and such a movement of the propeller shaft needs to be elastically supported in an appropriate manner.

In particular, since a shudder problem is caused by the vibration of the propeller shaft when the vehicle starts initially, it is necessary to develop a bushing which elastically supports the propeller shaft in a radial direction and an axial direction.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a hydraulic bushing which is mounted to be inserted onto an outer periphery of a propeller shaft, and effectively absorbs and reduces radial vibration and axial vibration in vertical and horizontal directions of the propeller shaft, thereby improving the vehicle steering stability and the comfortable ride.

Various aspects of the present invention provide a hydraulic bushing including a bushing body in which a plurality of pairs of upper fluid chambers and lower fluid chambers are formed in a circumferential direction, the upper fluid chamber and the lower fluid chamber of each pair being discriminated vertically in an axial direction, and an orifice including a vertical orifice passage communicating the upper fluid chambers with the lower fluid chambers, an upper orifice passage communicating the adjacent upper fluid chambers with each other, and a lower orifice passage communicating the adjacent lower fluid chambers with each other.

The bushing body may include a cylindrical portion at the center thereof, the cylindrical portion having an opened upper portion and a bottom surface at a bottom thereof. An upper partition wall, a middle partition wall, and a lower partition wall are formed to protrude from the cylindrical portion in a radial direction and have a circular shape in a circumferential direction, respectively. A vertical partition wall is formed to pass through the middle partition wall from the upper partition wall up to the lower partition wall along the axial direction. The plurality of upper fluid chambers are formed by the vertical partition wall, the upper partition wall, and the middle partition wall. The plurality of lower fluid chambers are formed by the vertical partition wall, the lower partition wall, and the middle partition wall.

A core is inserted into the cylindrical portion and is integrally formed with the bushing body.

Center rings are inserted into the upper partition wall and the middle partition wall and inserted into the lower partition wall and the vertical partition wall, respectively, and are integrally formed with the bushing body.

The orifice includes a cylindrical orifice body which has an opened upper portion and an opened lower portion and is assembled by fitting into an outer periphery of the bushing body. A first upper through-hole communicating with the upper fluid chamber is formed at an upper portion of the orifice body. A first lower through-hole communicating with the lower fluid chamber is formed under the upper through-hole and spaced apart from the upper through-hole. The vertical orifice passage is formed between the first upper through-hole and the first lower through-hole in the axial direction in order to communicate the first upper through-hole with the first lower through-hole.

A plurality of second upper through-holes communicating with the upper fluid chambers respectively are formed on left and right sides in a circumferential direction around the first upper through-hole. A plurality of second lower through-holes communicating with the lower fluid chambers respectively are formed on left and right sides in a circumferential direction around the first lower through-hole. A plurality of pairs each of which includes the two second upper through-holes are formed, and the second upper through-holes of each pair communicate with each other through the upper orifice passage. A plurality of pairs each of which includes the two second lower through-holes are formed, and the second lower through-holes of each pair communicate with each other through the lower orifice passage.

According to various aspects of the present invention, the plurality of fluid chambers partitioned in the vertical and circumferential directions communicate with one another by the vertical orifices and the circumferential orifices. Hence, the axial vibration of the propeller shaft is appropriately absorbed and reduced by the damping force generated by the flow of fluids through the orifices between the upper and lower fluid chambers, and the radial vibration of the propeller shaft is appropriately absorbed and reduced by the damping force generated by the flow of fluids through the orifices between the left and right fluid chambers. Therefore, the vibration and impact of the propeller shaft are reduced to thereby improve the vehicle steering stability and the comfortable ride.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of an exemplary bushing body according to the present invention.

FIG. 2 is a perspective view of an exemplary core according to the present invention.

FIG. 3 is a perspective view of an exemplary center ring according to the present invention.

FIG. 4 is a perspective view of an exemplary orifice according to the present invention.

FIG. 5 is a perspective view of an exemplary outer case according to the present invention.

FIG. 6 is a perspective view of an exemplary hydraulic bushing according to the present invention.

FIG. 7 is a cross-sectional view of the hydraulic bushing according to the present invention.

FIG. 8 is a view explaining the operation of the hydraulic bushing, upon axial vibration thereof, according to the present invention.

FIG. 9 is a view explaining the operation of the hydraulic bushing, upon radial vibration thereof, according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

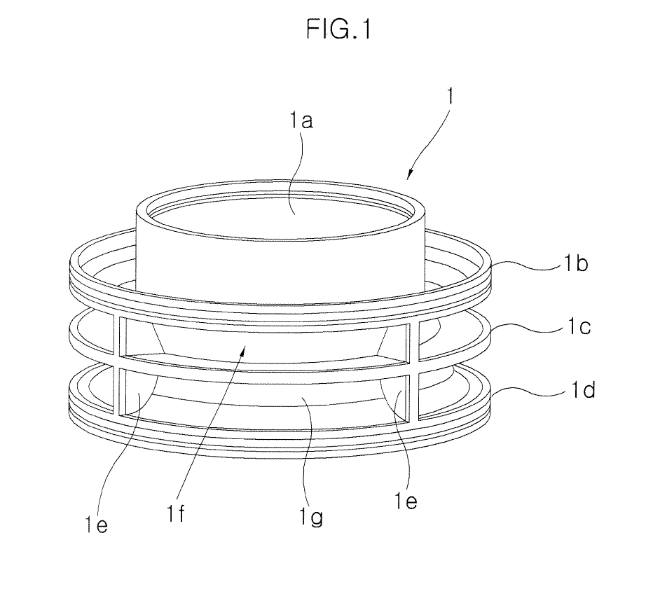

Referring to FIG. 1, a hydraulic bushing according to various embodiments of the present invention includes a bushing body 1. Bushing body 1 includes a cylindrical portion 1a at the center thereof. An upper portion of cylindrical portion 1a is opened, whereas a bottom surface is formed at the bottom of cylindrical portion 1a.

An upper partition wall 1b, a middle partition wall 1c, and a lower partition wall 1d are formed to protrude from cylindrical portion 1a in a radial direction and have a circular shape in a circumferential direction, respectively.

Upper partition wall 1b, middle partition wall 1c, and lower partition wall 1d are arranged at a predetermined interval in the axial direction of cylindrical portion 1a.

A vertical partition wall 1e is formed to pass through middle partition wall 1c from upper partition wall 1b up to lower partition wall 1d along the axial direction. Vertical partition wall 1e is formed in numbers at a predetermined interval along the circumferential direction.

A plurality of upper fluid chambers 1f are formed by vertical partition wall 1e, upper partition wall 1b, and middle partition wall 1c, and a plurality of lower fluid chambers 1g are formed by vertical partition wall 1e, lower partition wall 1b, and middle partition wall 1c. Upper fluid chambers 1f and lower fluid chambers 1g have predetermined volumes, respectively, and a fluid is inserted thereinto.

According to various embodiments of the present invention, four upper fluid chambers 1f and four lower fluid chambers 1g are formed in the circumferential direction, but the number thereof may be more than or less than four.

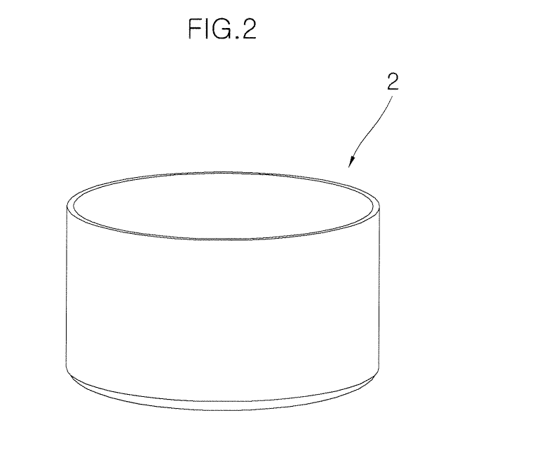

A core 2 is illustrated in FIG. 2. Core 2 is formed in a cylindrical shape having an opening at an upper portion thereof and a bottom surface at a lower portion thereof. As illustrated in the cross section of FIG. 2, core 2 is inserted into cylindrical portion 1a and may be integrally and/or monolithically formed with bushing body 1. Core 2 serves to allow bushing body 1 to maintain its stiffness.

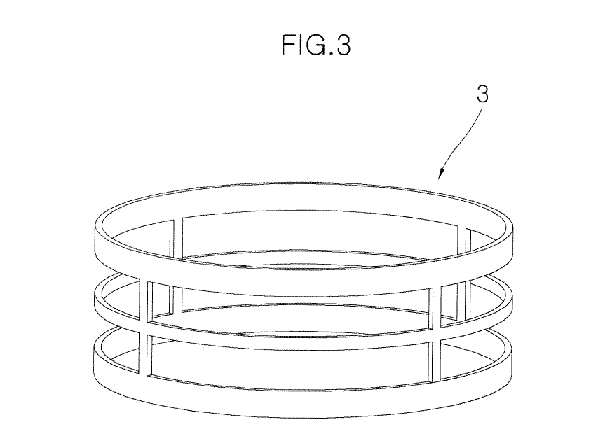

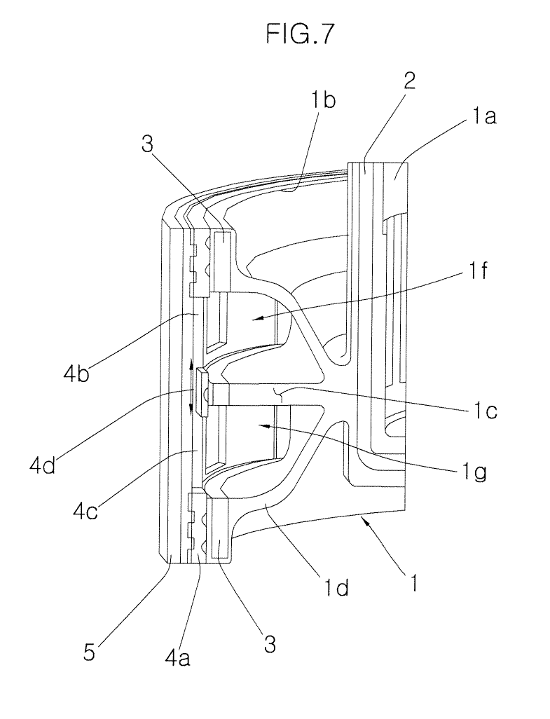

Center rings 3 formed to be integrally inserted into bushing body 1 are illustrated in FIG. 3. As illustrated in the cross section of FIG. 7, center rings 3 are inserted into upper partition wall 1b and middle partition wall 1c, and inserted into lower partition wall 1d and vertical partition wall 1e, respectively, and are integrally and/or monolithically formed with bushing body 1. Center rings 3 function to maintain stiffness of bushing body 1.

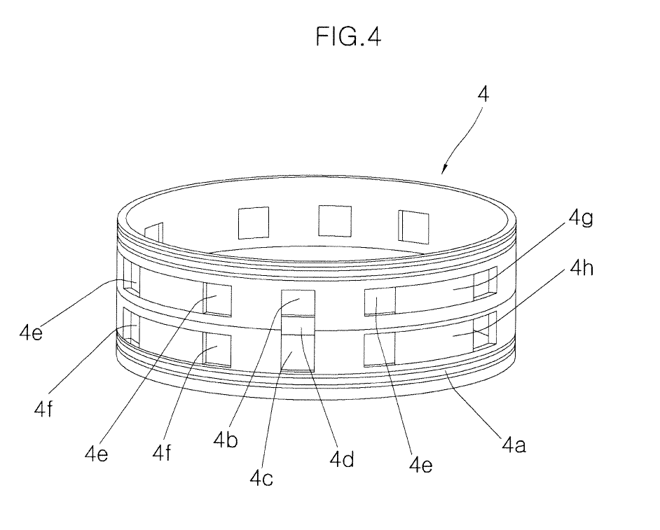

An orifice 4 according to various embodiments of the present invention is illustrated in FIG. 4. Orifice 4 includes a cylindrical orifice body 4a having an opened upper portion and an opened lower portion.

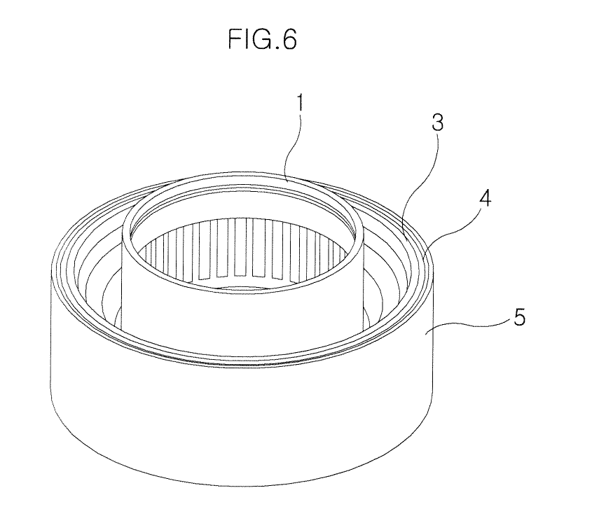

As illustrated in FIGS. 6 and 7, respectively, orifice 4 is assembled by fitting into the outer periphery of bushing body 1.

First upper through-holes 4b communicating with upper fluid chambers 1f are formed at the upper portion of orifice body 4a, and first lower through-holes 4c communicating with lower fluid chambers 1g are formed under upper through-holes 4b.

First upper through-holes 4b and first lower through-holes 4c are formed to be spaced apart from each other along the axial direction of orifice body 4a. As illustrated in the cross section of FIG. 7, vertical orifice passages 4d communicating first upper through-holes 4b with first lower through-holes 4c are formed between first upper through-holes 4b and first lower through-holes 4c in the axial direction.

Vertical orifice passages 4d are formed by recessing orifice body 4a inwardly from the outside thereof.

Four pairs of first upper through-holes 4b, first lower through-holes 4c, and orifice passages 4d are formed at a predetermined interval in the circumferential direction.

A plurality of second upper through-holes 4e communicating with upper fluid chambers 1f respectively are formed on the left and right sides in the circumferential direction around first upper through-holes 4b, respectively. That is, eight second upper through-holes 4e are formed.

In addition, a plurality of second lower through-holes 4f communicating with lower fluid chambers 1g respectively are formed on the left and right sides in the circumferential direction around first lower through-holes 4c, respectively. That is, eight second lower through-holes 4f are formed.

Four pairs each of which includes two second upper through-holes 4e are formed, and second upper through-holes 4e of each pair communicate with each other through an upper orifice passage 4g.

In addition, four pairs each of which includes two second lower through-holes 4f are formed, and second lower through-holes 4f of each pair communicate with each other through a lower orifice passage 4h.

Upper orifice passage 4g and lower orifice passage 4h are formed by recessing orifice body 4a inwardly from the outside thereof.

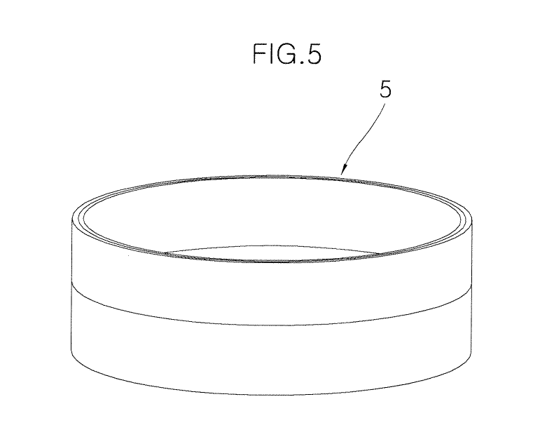

As illustrated in FIG. 5, an outer case 5 may be formed in a cylindrical shape having an opened upper portion and an opened lower portion. As illustrated in FIG. 6, outer case 5 may be assembled by fitting into the outer side of orifice 4.

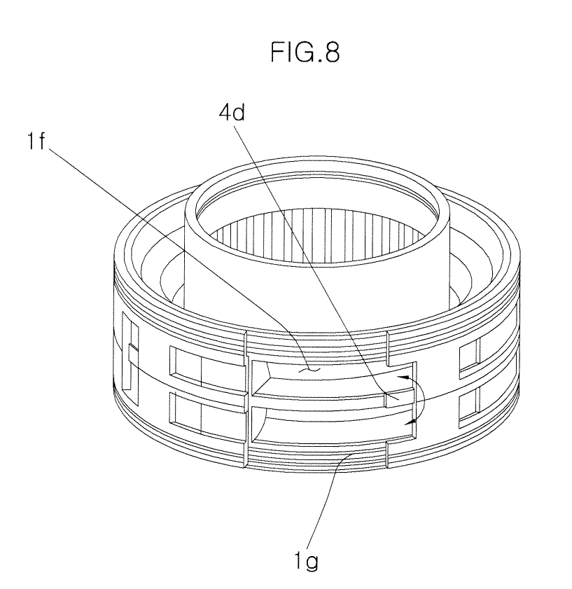

As indicated by arrows in FIGS. 7 and 8, respectively, when a propeller shaft vibrates in an axial direction in a state in which the bushing having the above-described construction according to various embodiments of the present invention may be assembled with the propeller shaft, the fluids of upper fluid chambers 1f and lower fluid chambers 1g flow through vertical orifice passage 4d, and a damping force generated during this process absorbs and reduces the axial vibration of the propeller shaft.

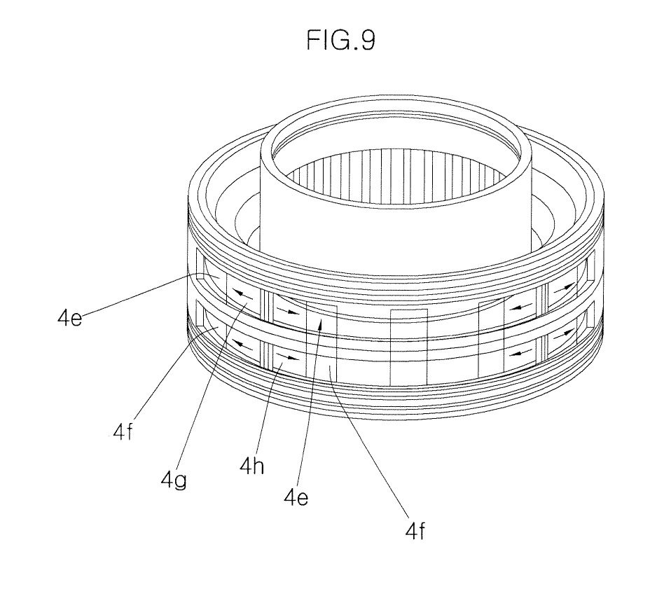

Meanwhile, as indicated by arrows in FIG. 9, respectively, when the propeller shaft vibrates in a radial direction in a state in which the bushing may be assembled with the propeller shaft, the fluids of upper fluid chambers 1f flow into adjacent upper fluid chambers 1f through upper orifice passage 4g, and the fluids of lower fluid chambers 1g flow into adjacent lower fluid chambers 1g through lower office passage 4h, and a damping force generated during this process absorbs and reduces the radial vibration of the propeller shaft.

It is apparent that a damping force may be generated by the flow of fluids between upper fluid chambers 1f and lower fluid chambers 1g.

For convenience in explanation and accurate definition in the appended claims, the terms upper or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hydraulic bushing comprising:
a bushing body including a plurality of pairs of upper and lower fluid chambers formed along a circumferential direction, each respective upper lower fluid chamber of each pair being vertically arranged with respect to one another in an axial direction; and
an orifice including a vertical orifice passage communicating the upper fluid chambers with the lower fluid chamber, an upper orifice passage communicating the adjacent upper fluid chambers with each other, and a lower orifice passage communicating the adjacent lower fluid chambers with each other.

2. The hydraulic bushing as defined in claim 1, wherein the bushing body includes a cylindrical portion at the center thereof the cylindrical portion having an opened upper portion and a bottom surface at a bottom thereof,
an upper partition wall, a middle partition wall, and a lower partition wall are formed to protrude from the cylindrical portion in a radial direction and have a circular shape in a circumferential direction, respectively,
a vertical partition wall is formed to pass through the middle partition wall from the upper partition wall up to the lower partition wall along the axial direction,
the plurality of upper fluid chambers are formed by the vertical partition wall, the upper partition wall, and the middle partition wall, and
the plurality of lower fluid chambers are formed by the vertical partition wall, the lower partition wall, and the middle partition wall.

3. The hydraulic bushing as defined in claim 2, further comprising a core which is inserted into the cylindrical portion and is integrally formed with the bushing body.

4. The hydraulic bushing as defined in claim 2, further comprising center rings which are inserted into the upper partition wall and the middle partition wall and inserted into the lower partition wall and the vertical partition wall, respectively, and are integrally formed with the bushing body.

5. The hydraulic bushing as defined in claim 1, wherein the orifice includes a cylindrical orifice body which has an opened upper portion and an opened lower portion and is assembled by fitting into an outer periphery of the bushing body,
a first upper through-hole communicating with the upper fluid chamber is formed at an upper portion of the orifice body,
a first lower through-hole communicating with the lower fluid chamber is formed under the upper through-hole and spaced apart from the upper through-hole, and
the vertical orifice passage is formed between the first upper through-hole and the first lower through-hole in the axial direction in order to communicate the first upper through-hole with the first lower through-hole.

6. The hydraulic bushing as defined in claim 5, wherein the vertical orifice passage is formed by recessing the orifice body inwardly from the outside thereof.

7. The hydraulic bushing as defined in claim 5, wherein a plurality of second upper through-holes communicating with the upper fluid chambers respectively are formed on left and right sides in a circumferential direction around the first upper through-hole,
a plurality of second lower through-holes communicating with the lower fluid chambers respectively are formed on left and right sides in a circumferential direction around the first lower through-hole,
a plurality of pairs each of which includes the two second upper through-holes are formed, the second upper through-holes of each pair communicating with each other through the upper orifice passage, and
a plurality of pairs each of which includes the two second lower through-holes are formed, the second lower through-holes of each pair communicating with each other through the lower orifice passage.

8. The hydraulic bushing as defined in claim 7, wherein the upper orifice passage and the lower orifice passage are formed by recessing the orifice body inwardly from the outside thereof.
